(19) United States
(12) Patent Application Publication
(10) Pub. No.: US 2006/0100737 A1
(43) Pub. Date: May 11, 2006

(54) Method for controlling and monitoring the production of thermoplastic extrusion profiles, particularly in an in-line production process comprising a printing step

(75) Inventor: Uwe Pohlmann, Munchberg (DE)

Correspondence Address: VENABLE LLP, P.O. BOX 34385, WASHINGTON, DC, 20045-9998, US

(73) Assignee: Rehau AG & Co., Rehau (DE)

(21) Appl. No.: 10/522,542

(22) PCT Filed: Jul. 5, 2003
(86) PCT No.: PCT/EP03/07211

§ 371 Date: Jan. 27, 2005

(30) Foreign Application Priority Data
Jul. 27, 2002 (DE) 102 34 276.8

(51) Int. Cl. G06F 7/66; B29C 45/76

(52) U.S. Cl. 700/196; 264/40.1; 706/904

(57) ABSTRACT

Disclosed is a method for controlling and monitoring the production of thermoplastic extrusion profiles, particularly in an in-line production process comprising a printing step, using an optical neuro-fuzzy-structured computer-designed image data-bank. The in-line production process is controlled and regulated from a central control desk in connection with an inspection device.

The present invention relates to a method for controlling and monitoring the production of thermoplastic extrusion profiles, particularly in an in-line production process comprising a printing step.

### PRIOR ART

The production of thermoplastic extrusion profiles as well as direct printing and imprinting methods are known in practical operation, wherein roll embossing and imprinting methods are used, e.g. as described in reference DE 2613411 C2. The method described in said reference is little suited to automated production and production sequences and the plurality of printed image variants for producing thermoplastic extrusion profiles such as edge bands, calenders and the like. In particular the long periods required for the retrofitting are extremely cost-intensive and time-consuming.

Reference DE 19823195 A1 discloses a production and digital printing method, as well as a device for printing on plastic surfaces. For this, the printing patterns are recorded digitally with the aid of a scanner or digital camera and are then supplied to a computer-printer unit. This unit controls the printing operation during the manufacturing process, wherein either ink-jet printers, laser printers, or thermo-transfer printers are used for the printing systems. This method has the disadvantage that data must be re-recorded by means of a data carrier such as a DC-Rom or other storage medium onto the computer-printer unit during the manufacturing process.

Reference DE 10049826 A1 describes a manufacturing process as well as a computer-controlled printing method for extruded plastic objects. The computer-supported printing method uses a number of printing patterns and image patterns, stored ahead of time in a computer, for controlling the printing process by means of a scanner and digital camera.

The computer-controlled method for producing and imprinting plastic objects has the disadvantage of requiring the intermediate steps of image storage and pattern storage, for which image-recording devices are used. For the multicolor printing, the technology of digital printing plates is known from literature, wherein the transfer of the digital printing image data to individual printing plates/rollers can occur outside of the printing system, in a so-called computer-to-plate printing method or through transfer of all digital image data to printing plates/rollers in a so-called computer-to-press method or through transfer of the digital image data onto image-carrier drums in the form of a so-called computer-to-print method.

The aforementioned methods and devices, which are known from prior art, have the disadvantage that they do not permit a defect-detecting control and monitoring of the thermoplastic extrusion profile production, particularly in an in-line production process with printing step.

As a rule, thermoplastic extrusion profiles are produced in a multi-stage production sequence comprising the following process steps:
providing the basic material;
processing the master batches for the extrusion operation, including adding the color;
extruding the product;
cooling in a cooling section;
surface pretreatment for the print preparation, depending on the basic materials used;
depositing of a bonding agent layer;
multi-stage printing operation using a client-specific design and/or pattern;
depositing an abrasion-resistant layer;
curing the coating by means of an irradiating device;
winding process and
preparing the product for shipping to the client.

The printing operation using client-specific printing patterns is a complex process due to changes in the printing/design images, printing colors, and the use of different types of basic materials and involves manual steps in prior art.

For an in-line production process for thermoplastic extrusion profiles, clients—for example clients in the furniture industry—would like to have models or pattern samples for thermoplastic extrusion profiles. For example, the client may request different versions or numbers of a finished edge band. If a client order is provided in the form of a printing pattern, the order is manually transmitted to the manufacturing section. The employees in the manufacturing section must then prepare the in-line production process for the thermoplastic extrusion profile based on the sample provided by the client, must ready the basic material, process the material for the master batches used in the extrusion process, and start the extrusion process and the following process sequences, including the printing step.

The printing process in particular comprises different process sequences and depends on the selection of the basic materials, the material pre-processing, the extrusion process control, and the surface treatment to prepare it for the printing operation. Production defects are unavoidable with such a complicated method for producing thermoplastic extrusion profiles according to client specifications with the desired printing and color designs/patterns. For example, the basic material used may not have the correct specification, the printing process may not be adjusted correctly, or the printed-on design may not meet the client requirements. In addition, the production systems used operate at high speeds and produce several meters of extrusion profile per minute.

Since defects in the finished product are not discovered until later on, time and material are used up. Accordingly, an efficient method is needed for controlling and monitoring the production of thermoplastic extrusion profiles, in particular in an in-line production process with printing step.

It is therefore the object of the present invention to create a method for controlling and monitoring the production of thermoplastic extrusion profiles, particularly in an in-line production process with printing step.

This object is solved with a method having the features as disclosed in patent claim 1, as well as a device as defined in patent claim 22. Further advantageous features follow from the dependent claims.

The neuro-fuzzy technology has been used in the industry for approximately 10 years, both for consumer goods and industrial goods, to model, analyze, control and optimize industrial manufacturing processes and/or monitoring techniques.

The method according to the invention for controlling and monitoring the production of thermoplastic extrusion profiles in an in-line production process with printing step provides for a first visual representation of a thermoplastic extrusion profile design/pattern on a display unit for an optical neuro-fuzzy structured computer/design/image data bank. For this, the client electronically sends a model for a pattern/design image of an extrusion profile to be produced via the Internet, e-mail, or a client-specific network to a design center, for example in the form of a tagged-image file format (TIFF format) or a joint-photographic experts group file format (JPEG format). These image models are electronically and optically stored in the optical neuro-fuzzy structured computer design/image data bank and are linked to the order for producing the image of a design and/or pattern for a thermoplastic extrusion profile.

The present invention uses an optical neuro-fuzzy structured computer design/image data bank to store material categories for producing the thermoplastic extrusion profiles, the printing pattern categories for the design/pattern printing, the associated production and control processes in the form of production/control process categories, including the monitoring sequences and the specific client instructions for assembly and packaging.

With an optical neuro-fuzzy structured computer design/image data bank, the basic material product parameters such as:
recipe data (polymers, additives, etc.) also for multilayer materials
color values and color pigmentation
   and the extrusion method parameters, including the cooling parameters:
temperature
pressure
batch—metering
extrusion tool
   and the preprocessing parameters such as:
flame treatment
use of plasma and/or chemical etching techniques, in particular the corona treatment
coating with a bonding agent for the subsequent printing step (primer coating)
   and the optical design/pattern image data and printing parameters such as:
decorative design
selection or combination of printing techniques such as the serial background printing and the piezo printing
printing color recipes
metamery adaptations
printing machinery adjustments
   and the coating parameters such as:
type of coating
surface embossing and surface structure
composition of the coating
post treatment
   and the optical inspection parameters such as:
design/pattern and color printing
defect/error images
defect locations
type of defect
   as well as the client-specific assembly and packaging parameters such as:
winding lengths
winding
packaging types
   are determined and combined according to the client requirements. A thermoplastic extrusion profile design/pattern is then created by means of the optical neuro-fuzzy structured computer design/image data bank and sent electronically via the Internet and/or e-mail and/or client-specific network to the client for release and approval of the design, including all material, color, and printing data, as well as the assembly and packaging data.

The aforementioned and listed parameters stored in the optical neuro-fuzzy structured computer design/image data bank must not be understood as restricting in any way.

The design/pattern image data are present in the form of image files, for example in the TIFF format or the JPEG format.

Following client approval and release of the designs/patterns, the material, color, and printing data as well as the assembly and packaging data and parameters, the optical neuro-fuzzy structured computer design/image data bank transfers the product parameters, the extrusion method parameters, the pretreatment parameters, the optical design/pattern and printing parameters, the coating parameters, the optical inspection parameters and the client-specific parameters for assembly and packaging electronically to a network which can be configured as cabled or radio-controlled Ethernet or any optional form of a local network and which is preferably present in the form of an intelligent neuronal network.

This intelligent neuronal network links at least two additional in-line production lines of the above-described type and determines the degree of utilization of the in-line production lines by means of an electronic production planning system.

In accordance with the result of an query from the production planning system via intelligent neuronal network, the optical neuro-fuzzy structured computer design/image data and parameters for the product parameters (basic material and formula data), for the extrusion method parameters, including the cooling (temperature, pressure, etc), for the pretreatment parameters (flame treatment, use of chemical and/or physical etching techniques, etc.), for the optical design/pattern image and printing parameters (decorative design, selection or combination of printing methods such as serial background printing and/or piezo printing, print color formula, etc.), the coating parameters (type of coating, surface embossing, etc.), the optical inspection parameters (design/pattern image and color printing, defect images and defect image categories, etc) and the client-specified assembly and packaging parameters are electronically transmitted to a central control station for controlling and regulating the production systems for the selected method for producing thermoplastic extrusion profiles, in particular several in-line production operations and the associated production systems.

Integrating a central control station into the control, regulation and monitoring process has the advantage that the operating personnel in the central control station can take over the control and monitoring of the production of thermoplastic extrusion profiles—also multiple processes—and can intervene directly so as to control and regulate the production sequence. The electronic and optical design/pattern image data, including the parameters for the production control and regulating devices, transmitted by the optical neuro-fuzzy structured computer design/image data bank, are displayed system specifically for the operating personnel at the central control station, wherein the in-line production processes are displayed with the aid of graphic user interfaces (called GUI).

The parameter data from an optical neuro-fuzzy structured computer design/image data bank, which are transmitted electronically and optically to the central control station, are thus used for the control and regulation of the following essential method steps of the in-line production process for thermoplastic extrusion profiles:
providing the basic material and material mixtures,
extrusion of the profiles with subsequent cooling,
material pretreatment for the printing step (by means of flame treatment, chemical and physical etching techniques and/or corona treatment),
mixing of the colors and the printing operation by means of serial background printing and/or piezo printing technique,
coating,
optical inspection of the extrusion profile,
assembly and packaging according to client specifications,
delivery notification to the client.

The basic material and/or the basic material mixtures—for example polyethylene, polypropylene, acryl butadiene styrene, polyvinylchloride etc.—as well as combinations of such mixtures are called up electronically via network by the central control station from the material storage facilities, are then fed via a material distribution system in a controlled manner to the extrusion process, are melted in a subsequent step and extruded according to client specifications by means of an extrusion method into thermoplastic extrusion profiles, based on the product and extrusion method parameters stored in the optical neuro-fuzzy structured computer design/image databank. The thermoplastic extrusion profiles are then allowed to cool during a subsequent cooling process in a temperature-controlled cooling section and based on the cooling parameter data, thus form-stabilizing the profiles.

For the material pretreatment for the printing process and to improve the adherence of the print colors to the thermoplastic extrusion profile, flaming treatments, physical and/or chemical etching techniques—selective and/or reactive ion etching and/or electrochemical etching—and/or a corona treatment are used, for which the pretreatment and method parameters are controlled and monitored by the central control station with the aid of the optical neuro-fuzzy structured design/image data and parameters. As a result, the thermoplastic extrusion profile, adapted to the material characteristics, is pretreated in the layer thickness range of 0.5-300 μm, preferably 2-200 μm, so that in the subsequent process step (primer coating) a bonding layer can be deposited by means of a coating device, controlled and regulated by the central control station.

The following step of imprinting the thermoplastic extrusion profile in a printing device, using a serial background printing technique and/or in combination with a piezo printing technique, is controlled by the central control station with the aid of the optical neuro-fuzzy structured design/pattern image data and the associated printing parameters.

In particular the printing operation with the background and/or piezo printing technique with multi-color design/pattern image data, including the associated printing parameters, are stored in the central control station in the form of optical neuro-fuzzy structured design/pattern printing image categories and print-control parameter categories for the printing process and advantageously ensure a quick activation of the printing device for a time-optimized printing operation.

According to one advantageous embodiment of the method according to the invention, the optical neuro-fuzzy structured design/pattern image data and the associated printing parameters, stored in the form of printing image categories, also control parallel printing operations of the aforementioned type (background and/or piezo printing techniques).

Following the printing step, an abrasion-resistant coating and in particular a coat of lacquer is deposited on the thermoplastic extrusion profile, wherein a multi-layer technique can also be used. For this, the optical neuro-fuzzy structured coating parameters are transmitted electronically via the central control station to a coating device for the purpose of controlling and regulating the coating process.

An optical inspection device as disclosed in patent claim 22 and embodied as image-recording camera with evaluation unit is used for the subsequent quality control of the printed-on and coated thermoplastic extrusion profiles. The pixel image for the inspected thermoplastic extrusion profile, generated at the output of the image-recording camera, is then transmitted electronically via radio and/or network to a second optical neuro-fuzzy structured data bank, henceforth called an optical neuro-fuzzy structured computer-aided inspection data bank. The optical neuro-fuzzy structured computer-aided inspection data bank then carries out an electronic and optical image comparison (image mapping) by comparing the stored pattern/design/image data to the pixel-image data present at the output of the picture-recording camera.

Detected deviations or defects in the printing (such as incorrect color, printing distortions, etc.) and/or in the coating (such as coating thickness, optical transmission behavior and reflection behavior of the coating, etc.) of the produced, printed-on, and coated thermoplastic extrusion profiles are detected by means of the electronic and optical image comparison (image mapping) of the recorded pixel data with the stored optical neuro-fuzzy structured pattern/design/image data and/or the coating parameters and are then transmitted via electronic network and/or radio-controlled to the central control station. There, they are stored as electronically and optically detected defect image data in the form of defect-image categories, classified by means of neuro-fuzzy technology, are data-technologically processed, and are used for the control and regulation of the printing and coating devices.

Following the neuro-fuzzy defect processing, the central control station in this way readjusts and regulates the process data and the process parameters for the printing device as well as the following coating device for the thermoplastic extrusion profiles. As a result, it is ensured that any defects that occur and the defect categories for the printing and/or coating operation are learned by the central control station and that the printing and coating devices are thus controlled and regulated with the new data and parameters to optimize the process.

The following client-specific assembly and packaging step is also controlled and regulated by the central control station using the assembly and packaging parameters. In the process, the detected printing/coating defects or defect categories are transmitted electronically and optically via a network and via the central control station to the assembly and packaging devices, which follow in the production process, to ensure that only thermoplastic extrusion profiles that are free of printing and coating defects are assembled and packaged for the final product, corresponding to the client specifications.

By means of the optical neuro-fuzzy structured design/image data bank and in connection with an Internet link, e-mail, or client-specific network, the client is then informed of the delivery time for the finished, assembled and packaged thermoplastic extrusion profiles without defects.

The advantages achieved with the invention among other things are that the thermoplastic extrusion profiles can be produced according to client specifications and can be adapted to changing print pattern/design images for a variety of basic materials and that a neuronal net linked a production planning system is used to detect the degree of utilization of the production processes.

The remaining dependent claims disclose advantageous individual features which are not discussed in further detail in the above, but which individually or in combination can be useful for solving the object.

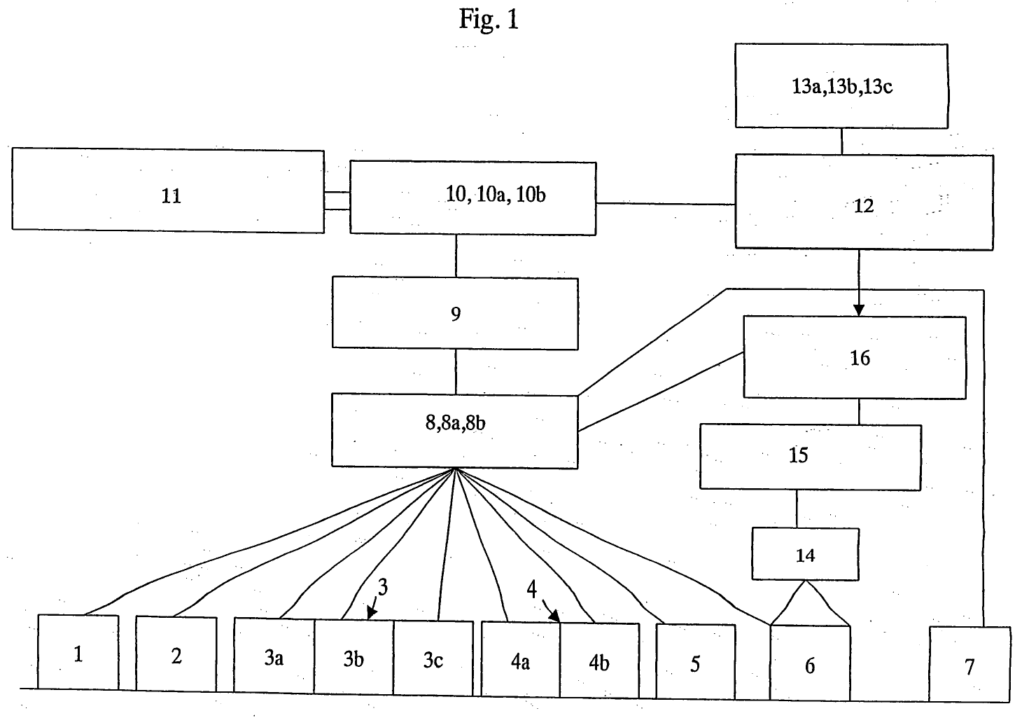

The invention is shown schematically with the aid of an embodiment in FIG. 1 and is discussed in further detail below with reference to the FIG. 1. The preferred exemplary embodiment along with the associated description and drawing must be viewed more in an illustrating than in a restricting manner.

In an in-line production process for producing thermoplastic extrusion profiles according to FIG. 1, the client electronically and optically sends design/pattern/image data for thermoplastic extrusion profiles via Internet connection 13a, e-mail 13b, or a client-specific network 13c to an optical neuro-fuzzy structured computer design/image data bank 12, for example in the form of electronic mail with design/pattern image models in the TIFF or JPEG file format. By means of the optical neuro-fuzzy structured computer design/image data bank 12, the product parameters (for the basic material, the basic-material mixture and the recipe data), the extrusion parameters, including the cooling parameters (pressure, temperature, etc.), the pretreatment parameters (flame treatment, use of chemical and/or physical etching techniques, etc.), the optical design/pattern image data and the printing parameters (decorative design, selection or combination of printing techniques such as the serial background and/or piezo printing, printing color recipe, etc.) for a serial background and/or piezo printing operation, the coating parameters (type of coating, surface embossing, etc.), the optical inspection parameters (design/pattern image and color printing, defect images and defect image categories, etc.) of the optical inspection device 6, as well as the client-specific assembly and packaging parameters are determined in their totality and combined according to client specifications and a thermoplastic extrusion profile design/pattern is then created. Once the thermoplastic extrusion profile design/pattern to be produced is approved by the client via electronic client link 13a-c, the product parameters, the extrusion parameters, the pretreatment parameters, the optical design/pattern image data, and the printing parameters for a serial background printing and/or piezo printing technique 4a,b to be used, the coating parameters, the optical inspection parameters, the client-specific assembly and packaging parameters, all of which are stored in the optical neuro-fuzzy structured computer design/image data bank 12, are transmitted to a network 10 which can be embodied as intelligent neuronal network 10b or also as cabled or radio-controlled Ethernet 10a. The intelligent neuronal network 10b links at least two in-line production lines 11 for producing thermoplastic extrusion profiles and detects with the aid of an electronic production planning system 9 the degree of utilization of several in-line production lines 11 for producing thermoplastic extrusion profiles.

Based on the query result and the degree of utilization determined for the individual in-line production lines 11 with the aid of a production-planning system 9, parameter and design/pattern data are transmitted electronically and optically from the optical neuro-fuzzy structured computer design/image data bank 12 via the network link 10, 10a-b to a central control station 8 to ensure a complete control and regulation of one or several of the selected in-line production lines 11.

The central control station 8 thus controls, regulates and monitors the complete process for producing thermoplastic extrusion profiles using the following method steps: providing the basic material from the material supply facility with distribution system 1, extruding and cooling of the profiles 2, pretreatment of the material by means of a chemical and/or physical etching method 3a-c, imprinting by means of a background printing technique 4a and/or a piezo printing technique 4b, coating 5, optical inspection 6, client-specific assembly and packaging 7 with the associated and allocated devices 1 to 7.

The electronic and optical neuro-fuzzy structured parameter and design/pattern image data are displayed for the operating personnel at the central control station 8 using a graphic user interface (GUI) 8a to visualize the system and method sequences. The operating personnel can thus visually monitor the system conditions of the activated devices 1 to 7, as well as the process parameters for producing the thermoplastic extrusion profiles, even those of several production lines.

The central control station 8 controls and regulates via an electronic network 8b the method step of supplying the basic materials and/or the basic material mixtures from the material supply facility 1 and, via a material distribution system, feeds these materials in a controlled manner to the extrusion device 2 for the extrusion process. For extruding the client-specified thermoplastic extrusion profile, the downstream-connected extrusion device 2 is actuated based on the product and extrusion method parameters stored in the optical neuro-fuzzy structured computer design/image data bank 12 and electronic data transmitted via the central control station 8 and the connected network 8b, so that the extrusion device 2 can extrude the profile according to client specifications.

The central control station 8 furthermore regulates and controls via the electronic network 8b the subsequent cooling process in a temperature-controlled cooling section, by means of the cooling parameters from the optical neuro-fuzzy structured computer design/image data bank, so as to ensure the format-stabilization of the thermoplastic extrusion profile.

For the material pretreatment for the printing process realized in the printing device 4, 4a-b and to improve the adherence of the printing colors to the thermoplastic extrusion profiles, the central control station 8 via the electronic network 8b controls in the following step the flaming device 3a and/or the physical and/or the chemical etching device 3b, including the corona treatment in a material treatment device 3, in accordance with the pretreatment parameters and the process parameters stored in the central control station 8 and using the optical neuro-fuzzy structured computer design/image data and the parameters 12. As a result, the thermoplastic extrusion profile is pretreated in the a layer thickness range of 0.5-300 μm, so that in the following method step a bonding layer can be deposited with the aid of the coating device 3c. The subsequent step of imprinting the thermoplastic extrusion profile in a printing device 4 by means of a serial background printing technique 4a and/or in combination with a piezo printing technique 4b is controlled by the central control station 8 via the electronic network 8b and the optical neuro-fuzzy structured computer design/pattern image data 12 as well as the associated printing parameters. The printing design/pattern images, stored in the central control station 8 in the form of optical neuro-fuzzy structured design/pattern image and printing control categories, ensure a quick and therefore time-optimized printing operation in the printing device 4 by means of the serial background printing technique 4a and/or the piezo printing technique 4b.

The coating operation (sealing) is realized in a downstream-arranged coating device 5 which is controlled by the central control station 8 via the network 8b, using the coating parameters from the optical neuro-fuzzy structured computer design/image data bank 12.

Following the printing operation 4 with the printing techniques 4a, 4b and following the coating operation in the coating device 5, the thermoplastic extrusion profiles that are produced are then inspected with the aid of an optical inspection device 6, comprising an image-recording camera with evaluation unit 14.

Electronic and optical pixel images and pixel-image data 15 of the thermoplastic extrusion profile, specifically of its design/pattern image and the coating, are generated at the output of the image-recording camera with evaluation unit 14. This pixel-image information consequently comprises a detailed, accurate image of the inspected thermoplastic extrusion profile and is transmitted electronically, via network or radio, to an optical neuro-fuzzy structured computer-aided inspection data bank 16.

The optical neuro-fuzzy structured computer-aided inspection data bank 16 carries out an electronic and optical image comparison (image mapping) between the stored pattern/design image data from the optical neuro-fuzzy structured computer design/image data bank 12 and the pixel data at the output of the image-recording camera with evaluation unit 14, to ensure a timely detection of production-related deviations or defects caused in the printing device 4, using the printing techniques 4a-b, and/or the defects in the coating applied with the coating device 5. The defects and deviations detected in this way are then transmitted to the central control station 8 via the network 8b and are stored in the central control station 8 in the form of optically and electronically detected defect-image categories based on a neuro-fuzzy logic categorization.

The electronic and optical neuro-fuzzy categorized defect and deviation data from the optical neuro-fuzzy structured computer-aided inspection data bank 16, stored in the central control station 8, are processed data-technologically in the central control station 8 and are used to correct the production-dependent defects occurring in the printing device 4 using the background printing technique 4a and/or the piezo printing technique 4b and/or defects in the coating device 5, in accordance with the detected and ascertained defects and defect categories.

In the process, the central control station 8 simultaneously transmits the production-dependent defects and defect categories to the assembly and packaging device 7, so that the printed-on and coated thermoplastic extrusion profiles, recognized as defective, are detected and removed by the assembly and packaging device 7 and the thermoplastic extrusion profiles without defects are assembled and packaged according to the client specifications and based on the assembly/packaging parameters stored in the optical neuro-fuzzy structured design/image data bank 12.

The client is then informed electronically via network connection 13a-c, e-mail message, Internet connection, or client-specified network of the delivery date for the completed, assembled and packaged thermoplastic extrusion profiles.

### REFERENCE NUMBER LIST

1 material supply facility with distribution system
2 extrusion device with cooling section
3 material pretreatment device
3a flaming device
3b physical and/or chemical etching device
3c coating device for applying a bonding layer
4 printing device
4a background printing technique
4b piezo printing technique
5 coating device
6 optical inspection device
7 assembly and packaging device
8 central control station
8a graphic-user interface (GUI)
8b electronic network connecting the central control station to the devices 1 to 7
9 production planning system
10 electronic network
10a a cabled or radio-controlled Ethernet
10b intelligent neuronal network
11 in-line production lines—at least two
12 optical neuro-fuzzy structured computer/design image data bank
13a Internet connection
13b e-mail network connection
13c client-specific network
14 image-recording camera with evaluation device
15 pixel image data at the output of the image-recording camera
16 optical neuro-fuzzy structured computer-aided inspection data bank

1. A method for controlling and monitoring the production of thermoplastic extrusion profiles, particularly in an in-line production process with print step, characterized by the following features:
(a) The use of an optical neuro-fuzzy structured computer/design image data bank (12) for a visual representation of a thermoplastic extrusion profile design/pattern, wherein
(b) the client transmits a model for a pattern/design image of an extrusion profile to be produced in electronic form, meaning via the Internet, e-mail, or a client-specific network (13a-c) and using a TIFF and/or JPEG file and/or a different data format, to the optical neuro-fuzzy structured computer/design image data bank (12), and wherein the image models are stored electronically and optically in the optical neuro-fuzzy structured computer/design image data bank (12) and are linked to
(c) an order for producing a design and/or pattern image of a thermoplastic extrusion profile and
(d) in the optical neuro-fuzzy structured computer/design image data bank (12), the production parameters for the basic materials supplied by the material supply facility (1), the extrusion parameters, including the cooling parameters for the extrusion device with cooling section (2), the pretreatment parameters for the material pretreatment device (3, 3a-c), the optical design and pattern image data and the printing parameters for the printing device (4), using the serial background printing technique (4a) and/or the piezo printing technique (4b), the coating parameters for the coating device (5), the optical inspection parameters for the optical inspection device (6), and the assembly and packaging parameters for the assembly and packaging device (7) are electronically and optically determined, and
(e) a serial background printing technique (4a) and/or a piezo printing technique (4b) is then selected for the printing device (4) with the aid of the printing and image/design parameters stored in the optical neuro-fuzzy structured computer/design image data bank (12), and
(f) the client is sent an electronic confirmation via the Internet, e-mail or a client-specific network (13a-c) from the optical neuro-fuzzy structured computer/design image data bank (12) of the product and design parameters for producing a thermoplastic extrusion profile.

2. The method according to claim 1, characterized in that the optical and electronic data for the design parameters, the method parameters, and the product parameters are transmitted via optical neuro-fuzzy structured computer/design image data bank (12) to an electronic network (10) and/or a cabled and/or radio-controlled Ethernet (10a).

3. The method according to claim 2, characterized in that the electronic network (10) is an electronic intelligent neuronal network (10b).

4. The method according to claim 2, characterized in that an intelligent neuronal network (10b) connects at least two additional in-line production lines (11) for producing thermoplastic extrusion profiles and wherein an electronic production planning system (9) determines the degree of utilization of the individual in-line production lines (11).

5. The method according to claim 1, characterized in that the optical neuro-fuzzy structured computer/design image data bank (12) electronically transmits to a central control station (8) the product parameters for the basic materials, the extrusion method parameters—including the extrusion cooling parameters—the pretreatment parameters, the optical design and pattern image data and the printing parameters for the serial background printing and/or piezo printing techniques (4a,b), the coating parameters, the optical inspection parameters, as well as the assembly and packaging parameters.

6. The method according to claim 5, characterized in that the optical and electronic neuro-fuzzy structured computer/design image data transmitted by the data bank (12) to the central control station (8) on the whole are used to control, regulate and monitor the production of at least one in-line production line (11) with the associated devices (1-7) and using the following production steps:
(a) providing the basic material and material mixture;
(b) extrusion with subsequent cooling;
(c) material pretreatment for the printing operation;
(d) printing by means of a serial background printing technique (4a) and/or a piezo printing technique (4b);
(e) coating
(f) optical inspection of the extrusion profile;
(g) client-specific assembly and packaging.

7. The method according to claim 6, characterized in that the electronic and optical neuro-fuzzy structured computer/design image data from the data bank (12) are used to display for the operating personnel in the central control station (8) the production control parameters and the production regulation parameters of the production devices (1-7) by means of a graphic user interface (8a).

8. The method according to claim 6, characterized in that the central control station (8) via a network electronically transmits a request for the basic material and/or basic material mixtures, e.g. polyethylene, polypropylene, acryl butadiene styrene, polyvinylchloride etc or mixture combinations, to a material supply facility with distribution system (1) and supplies these materials to the extrusion device (2) for the extrusion process.

9. The method according to claim 6, characterized in that the central control station (8) controls and regulates the extrusion process in the extrusion device (2), such that the thermoplastic extrusion profiles are extruded according to client specifications and corresponding to the product parameters and the extrusion parameters stored in the optical neuro-fuzzy structured computer/design image data bank (12).

10. The method according to claim 6, characterized in that following the extrusion, the central control station (8) controls and regulates the temperature for the cooling process of the extruded thermoplastic profile.

11. The method according to claim 6, characterized in that the central control station (8) controls and regulates the material pretreatment process in a material pretreatment device (3) by means of the pretreatment and process parameters.

12. The method according to claim 11, characterized in that the material pretreatment device (3) comprises a flame-treatment device (3a) and a physical and/or chemical etching device (3b).

13. The method according to claim 12, characterized in that the physical and/or chemical etching device (3b) realizes a selective and/or reactive ion etching process and/or electro-chemical etching process on the thermoplastic extrusion profile.

14. The method according to claim 12, characterized in that the neuro-fuzzy structured computer/design image data bank (12) controls and regulates the pretreatment parameters and the method parameters for the etching device (3b), as well as the etching process on a thermoplastic extrusion profile in the layer thickness range of 0.5 to 300 μm, preferably in the layer thickness range of 2 to 200 μm, adapted to the material properties of the thermoplastic extrusion profile.

15. The method according to claim 6, characterized in that following the etching process a bonding agent layer is deposited inside a coating device (3c) of the material pretreatment device (3), which deposit is controlled and regulated by the central control station (8).

16. The method according to claim 6, characterized in that the central control station (8) controls and regulates the printing step for the thermoplastic extrusion profiles in a printing device (4), using the neuro-fuzzy structured design/pattern image data and the associated printing parameters from data bank (12).

17. The method according to claim 16, characterized in that the printing device (4) makes use of a background printing technique (4a) and/or a piezo printing technique (4b).

18. The method according to claim 16, characterized in that the multi-colored design/pattern image data and the printing parameters for the printing operation are stored in the central control station (8) in the form of neuro-fuzzy structured design/pattern printing image categories and print-control parameter categories to permit a faster actuation of the printing device (4) which uses the serial background printing technique (4a) and/or the piezo printing technique (4b).

19. The method according to claim 16, characterized in that the central control station (8) controls and regulates the parallel background printing (4a) and/or piezo-printing techniques (4b) in a printing device (4) by means of the optical neuro-fuzzy structured design/pattern image data and the associated printing parameters, stored in the form of print image categories.

20. The method according to claim 6, characterized in that the central control station (8) controls and regulates a coating device (5) with the aid of the optical neuro-fuzzy structured coating parameters.

21. The method according to claim 20, characterized in that the coating device (5) deposits an abrasion-resistant layer, in particular a coat of lacquer, onto the thermoplastic extrusion profile.

22. The device according to claim 6, characterized in that an optical inspection device (6), comprising an image-recording camera and an evaluation unit (14), records the thermoplastic extrusion profile and transmits the optical and electronic pixel image data (15) to an optical neuro-fuzzy structured computer-aided inspection data bank (16) via radio or electronic network.

23. The device according to claim 22, characterized in that an electronic and optical image comparison (image mapping) is made between the pixel image data (15) in the optical neuro-fuzzy structured computer-aided inspection data bank (16) and the stored optical neuro-fuzzy structured computer design/design image data (12) for detecting production-related deviations and defects in the printing, applied by the printing device (4; 4a-b), and/or in the coating deposited by the coating device (5).

24. The device according to claim 22, characterized in that the detected, production-related deviations and defects are transmitted via radio or network in the form of optical and electronic data from the optical neuro-fuzzy structured computer-aided inspection data bank (16) to the central control station (8) where they are categorized by means of neuro-fuzzy technology and stored as electronically and optically detected defect image data in the form of defect image categories.

25. The method according to claim 6, characterized in that the stored neuro-fuzzy categorized defect image data/categories are processed data-technologically in the central control station (8) and that the central control station (8) controls and regulates the correction of these production-related defects, occurring in the printing device (4) that uses the background printing technique (4a) and/or the piezo printing technique (4b), by means of the electronic network (8b).

26. The method according to claim 6, characterized in that the central control station (8) transmits the defect data for the printing and/or coating operation via electronic network (8b) to the assembly and packaging device (7) and that the assembly and packaging device (7) removes the defective thermoplastic extrusion profiles.

27. The method according to claim 6, characterized in that the thermoplastic extrusion profiles produced without defects are assembled and packaged according to client specifications and based on the assembly/packaging parameters stored in the optical neuro-fuzzy structured computer/design image data bank (12).

28. The method according to claim 1, characterized in that the client is notified via network connection (13a-c) of the delivery time for the finished thermoplastic extrusion profiles.
